(19) United States
(12) Patent Application Publication
(10) Pub. No.: US 2011/0019176 A1
(43) Pub. Date: Jan. 27, 2011

(54) 3D LASER RANGE FINDER SENSOR

(76) Inventor: Hyuno Kim, Seoul (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/842,690

(22) Filed: Jul. 23, 2010

(30) Foreign Application Priority Data
Jul. 24, 2009 (KR) 10-2009-0067680

(51) Int. Cl. G01C 3/08

(52) U.S. Cl. 356/5.01

(57) ABSTRACT

Disclosed herein is a 3-dimension range finder sensor, the proposed range finder sensor including a mirror reflecting emitted light and incident light; a mirror support tiltably supporting the mirror; a cylindrical body coupling the mirror support to its one side and being of a hollow shape in at least one part to allow the emitted light and the incident light to pass therethrough; a horizontal drive motor installed on a base for supportively rotating the cylindrical body; a link device connected to the mirror for tilting the mirror; a vertical drive motor disposed at a lateral surface of the horizontal drive motor on the base; and a power transmission part interposed between the vertical drive motor and the link device and transmitting the power of the vertical drive motor to the link device for the link device to tilt the mirror.

### CROSS-REFERENCE TO RELATED APPLICATION

This application claims the benefit under 35 U.S.C. §119 of Korean Application No. 10-2009-0067680, filed Jul. 24, 2009, which is hereby incorporated by reference in its entirety.

### BACKGROUND

1. Field of the Invention

The present invention relates to a three dimension range finder sensor, more particularly to a 3-D range finder sensor capable of reducing the size of a product through the structure improvement of a horizontal drive system and a vertical drive system.

2. Description of the Related Art

The range finder sensor comprised of a light source, a rotating body, and a sensor detects the signal through a sensor, performs a series of numerical calculations and determines a distance in a case light emitted from a light source hits an object and turns back again. The rotating body helps determine a distance to the object within a given angle boundary by changing the angle of emitted light and incident light.

Such a range finder sensor is generally in a structure of performing a distance determination of a first dimension section. That is, it can scan an object in a horizontal direction. In order to implement a 3-D range finder sensor that can scan in a horizontal direction as well as a vertical direction, a mirror within an LRF (Laser Range Finder) structure needs to move in a horizontal direction as well as in a vertical direction. In order to move the mirror in a horizontal direction and in a vertical direction, a horizon drive system and a vertical drive system are used.

The conventional three dimension range finder sensor uses a spindle motor as a horizontal drive system, and uses a stepping motor as a vertical drive motor. The spindle motor is comparatively disposed in the lower part, and the stepping motor is disposed in the upper part of the spindle motor.

However, there lies a problem in the prior-art 3-D range finder sensor that a support part of a hollow axis fixed at a spindle motor, as a horizontal drive part for mirror rotation, is placed on the lower part of a product so that the run-out of the upper part is relatively great to which the mirror is combined.

Also, due to a structure in which a hollow-type stepping motor as a vertical drive part for the tilting drive of a mirror is stacked over a spindle motor, a product height in the prior-art 3-D range finder sensor increases to make it difficult to miniaturize the sensor.

Also, as another problem in the prior-art 3-D range finder sensor, there is great friction load because of a number of power transmission components from a rotor to a screw axis in the vertical drive part, and since a portion in which the vertical drive part is connected to the horizontal drive part is an outer ring rotation type that is attached to a bearing outer racing, it is difficult to provide a space safely supporting the sliding of a screw axis so that the variation of the pitch angle of the mirror becomes larger.

The present invention has been devised to overcome the above-mentioned problems, and it is a technical subject to provide a 3-dimensional range finder sensor configured to reduce the run-out of a product through the structure improvement of a horizontal drive system and a vertical drive system in order to move a mirror, to be advantageous for a mirror to obey an angle control angle, and to reduce a product size through the appropriate employment of an effective space.

Technical challenges to be achieved by the present invention are not limited to the above-mentioned technical challenge, and other not-mentioned technical challenges would be clearly understood by those skilled in the art from the accompanying recitation.

### BRIEF SUMMARY

To solve the aforementioned challenges, a 3-dimension range finder sensor according to the present invention comprises: a mirror reflecting emitted light and incident light; a mirror support tiltably supporting the mirror; a cylindrical body coupling the mirror support to its one side and being of a hollow shape in at least one part to allow the emitted light and the incident light to pass therethrough; a horizontal drive motor installed on a base for supportively rotating the cylindrical body; a link device connected to the mirror for tilting the mirror; a vertical drive motor disposed at a lateral surface of the horizontal drive motor on the base; and a power transmission part interposed between the vertical drive motor and the link device and transmitting the power of the vertical drive motor to the link device for the link device to tilt the mirror.

### BRIEF DESCRIPTION OF THE DRAWINGS

FIG. 1 is a perspective view indicating a 3-dimension range finder sensor according to one embodiment of the present invention;

FIG. 2 is a plan view indicating a 3-dimension range finder sensor according to one embodiment of the present invention; and

FIG. 3 is a cross section view taken along line I-I of FIG. 2.

### DETAILED DESCRIPTION

Hereinafter, a 3-dimension range finder sensor according to one embodiment of the present invention will be described in detail with reference to the annexed drawings.

In describing the present invention, the size, shape, etc. of components shown in the drawings may be exaggerated or simplified for the sake of clarity and conveniences. Also, specially defined terms in consideration of the construction and function of the present invention may be varied according to the intention and custom of a user and an operator. Such terms should be interpreted into the meaning and scope matching to the technical spirit of the present invention based on recitations throughout the entire specification.

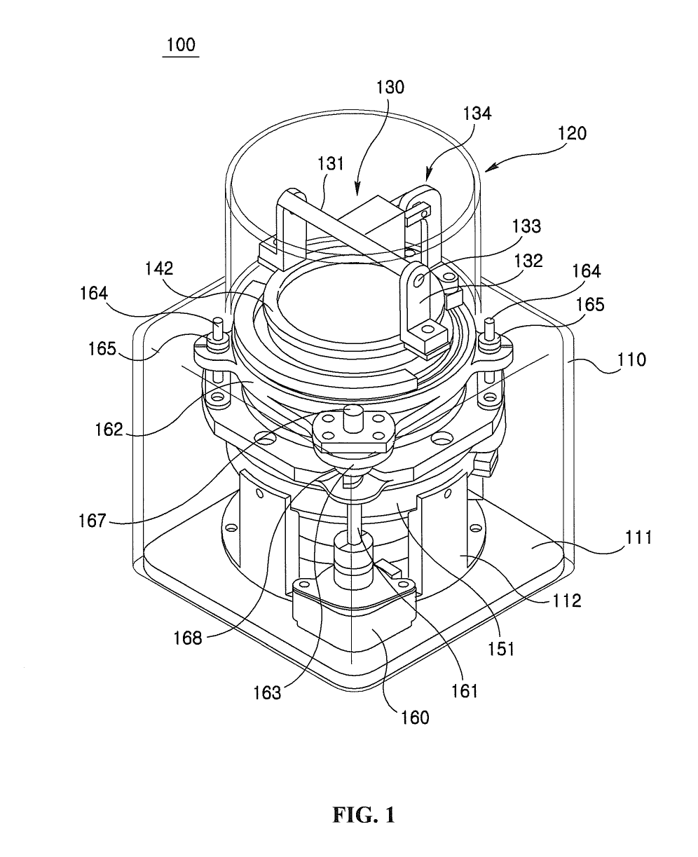

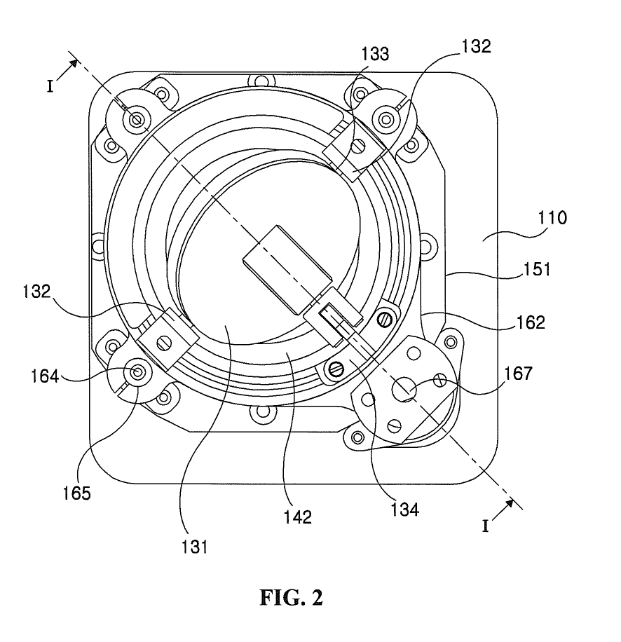

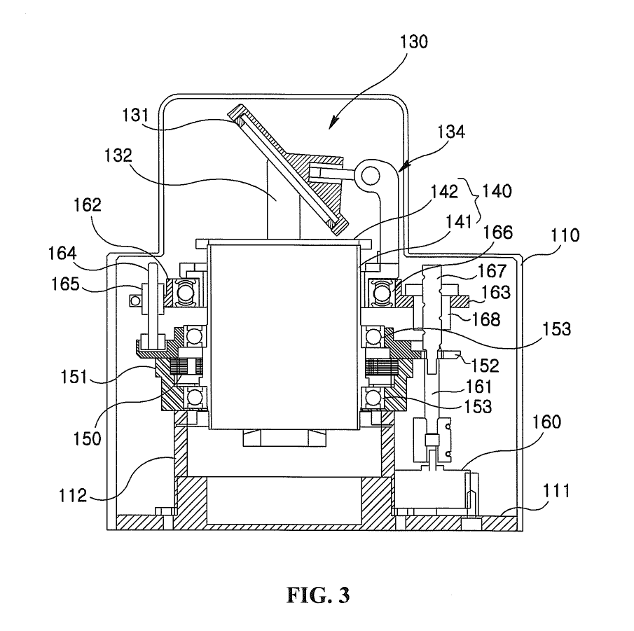

FIG. 1 is a perspective view indicating a 3-dimension range finder sensor according to one embodiment of the present invention, FIG. 2 is a plane view indicating a 3-dimension range finder sensor, and FIG. 3 is a cross section view taken along line I-I.

As shown in FIG. 1, a 3-dimension range finder sensor according to an embodiment of the present invention largely includes a main body 110 and an LRF (Laser Range Finder) structure 120. In the main body 110, a light reception device sensing incident light as an optical signal, a light focusing lens focusing inputted incident light into the light reception device, and a light emitting device emitting light using a laser are installed.

Light produced in the light emitting device is reflected by the mirror 131 and emits outwards as a signal optic. A direction of emitted light is varied according to the rotation position and inclination of the mirror 131. When the emitted light hits an object and turns back as a signal optic, the signal optic is reflected by the mirror 131, incident on the interior of the main body 110, through the light focusing lens and then incident on the light reception device. As such, the 3-dimension range finder sensor 100 according to one embodiment of the present invention may perform a scanning that illuminates emitting light and radiates through the mirror 131, and focuses the incident light, which hitting the object and turning back, through the mirror 131, as a normal one does.

The LRF structure 120 may perform a 3-dimension range finder (range finder) through the rotation and the inclination of the mirror 131. The mirror 131 is supported by a link device 134 and a mirror support axis 133 combined at a pair of a mirror support 132, possibly capable of a tilting operation. Such a mirror assembly 130 may be coupled to the upper part of a rotating body 140 to freely rotate with the rotating body 140.

At this time, the mirror 131 is tilted by the vertical movement of the link device 134, so that an elevation bearing 166 installed with the link device 134 is provided to go up/down along the rotating body 140. That is, the cylindrical body 140, the pair of mirror supports 132, the mirror support axis 133 and the link device 134 are connected to each other and rotate around a same axis, and the lower end part of the link device 134 is connected to the inner ring of the elevation bearing 166, and the inner ring of the elevation bearing 166 is elevatingly inserted around the outer circumference of the rotating body 140.

The outer ring of the elevation bearing 166 is integrated with a bracket 163 of a vertical movement body 162, and a nut member 168 is fixed in the bracket 163. The nut member 168 and the screw axis 167 are combined with a screw. When a screw axis 167 is rotated, the nut member 168, the bracket 163, the outer circumference and inner ring of the elevation bearing 166, and the link device 134 are going up/down, thereby tilting the mirror 131.

The screw axis 167 is connected to the drive axis 161 of the vertical drive motor 160, and the vertical drive motor 160 and the horizontal drive motor 150 are separately controllable. According to the rotation angle of the vertical drive motor 160 and the horizontal drive motor 150, the rotation and tilting of the mirror 131 are simultaneously possible.

The horizontal drive motor 150 is installed in the base 111, supporting and rotating, the cylindrical body 141. The link device 134 is connected to the mirror 131, tilting the mirror 131. The vertical drive motor 160 is disposed in the base 111 as the side surface of the horizontal drive motor 150. The power transmission unit 170 is inserted between the vertical drive motor 160 and the link device 134, and delivers the power of the vertical drive motor 160 to the link device 134 to enable the link device 134 to tilt the mirror 131.

Such a power transmission unit 170 includes an elevation bearing 166, a screw axis 167, and a nut member 168, is a power transmission means for the vertical movement of the link device 134.

The elevation bearing 166 is connected to the vertical drive motor 160 for rotating and vertically moving the link device 134. Here, the inner ring of the elevation bearing 166 is slidingly inserted into the cylindrical body 141, and is connected to the link device 134, and the outer circumference of the elevation bearing 166 may be connected to the vertical drive motor 160.

The screw axis 167 is coupled to the drive axis 161 of the vertical drive motor 160. The nut member 168 is screw-connected to the screw axis 167, and is connected to the elevation bearing 166, and it vertically moves the elevation bearing 166 by going up and down when the vertical drive motor 160 is rotated.

The guide axis 164 guides the vertical movement of the link device 134. The vertical drive motor 160 is disposed in the opposite side of the guide axis 164 with placing the cylindrical body 141 between them. Here, three of the guide axis 164 and the vertical drive motor 160 are in the periphery of the cylindrical body 141 with 90° interval. Because the vertical drive motor 160 is disposed at an unemployed void space of the tap part (the bottom-right edge of FIG. 2) of the base 110, the size of the apparatus may be reduced. The cylindrical body 141 is supported in both ends to be rotated by a pair of a rotating body support bearings 153 provided at the lower side of the elevation bearing 166. The elevation bearing 166 is capable of freely going up/down because it is disposed at the upper side of the rotating body support bearing 153.

As shown in FIGS. 1 through 3, the rotating body 140 includes the cylindrical body 141 and a mirror support body 142. Because the cylindrical body 141 is empty in its interior, emitted light or incident light through the interior of the cylindrical body 141 and through the mirror 131 may be transmitted to the main body 110. The cylindrical body 141 is rotated by the horizontal drive motor 150. The mirror support body 142 is formed at the upper part of the cylindrical body 141 and connected to a pair of mirror supports 132.

The horizontal drive motor 150 is supported by a motor support body 151, and the motor support body 151 is coupled to a fixation body connected to the base 111. In the inner side of the motor support body 151, a pair of cylindrical support bearings 153 is installed at the upper/lower side with placing the horizontal drive motor 150 between them to support the cylindrical body 141 rotatingly. The horizontal drive motor 150 is disposed along the outer periphery surface of the cylindrical body 141 to rotate the cylindrical body 141.

The cylindrical body 141 may be rotated by the horizontal drive motor 150, and it corresponds to the rotation axis of the horizontal drive motor 150, and it can only rotate around the vertical axis of the horizontal drive motor 150, restricted in a vertical movement.

On the one hand, the vertical movement body 162 is supported to be slidingly moved by a plurality of guide axis 164 coupled to the motor support body 151. The guide axis 164 is disposed in parallel to the cylindrical body 141. An axis support member 165 is coupled to a bracket 163 of the vertical movement body 162, and the guide axis 164 is inserted into this axis support member 165. In the inner side of the vertical movement body 162, an elevation bearing 166 supporting rotatingly the link device 134 supporting for the mirror 131 to have any pitch angle is installed.

The vertical drive motor 160 is disposed at the outer side of the rotating body 140 and the horizontal drive motor 150. That is, the vertical drive motor 160 is disposed at the outer edge part of the rotation body 140 and the horizontal drive motor 150, so that it can reduce the product height compared to in a previous case a horizontal drive motor is installed over a vertical drive motor. At this time, the thrust of the vertical drive motor 160 is delivered to the mirror 131 through the screw axis 167 and the nut member 168.

The drive axis 161 of the vertical drive motor 160 penetrates the bracket 152 of the motor support body 151 at its end portion, and the end portion of the drive axis 161 is coupled to the screw axis 167. The screw axis 167 is screw-coupled to the nut member 168 coupled to one side of the vertical movement body 162. Thus, when the screw axis 167 is rotated, the nut member 168 moves in a vertical direction by an external force. By such an action of the screw axis 167 and the nut member 168, the vertical movement body 162 shifts slidingly along the guide axis 164.

As such, because the rotation body 140 supporting the mirror assembly 130 rotates and shifts up and down by the horizontal drive motor 150 and the vertical drive motor 160, the mirror 131 may rotate by 360° and move up/down and reflect emitted light and incident light. The following is an action where the mirror 131 moves by the horizontal drive motor 150 and the vertical drive motor 150.

In a case the horizontal drive motor 150 operates, a cylindrical body 141 rotatingly supported by a pair of rotation body support bearings 153 and the mirror support body 142 coupled at the upper side of the cylindrical body 141 rotate. In a case the mirror support body 142 rotates, a pair of mirror supports 132 coupled to the mirror support body 142 and the link device 134 connected to this and the inner ring of the elevation bearing 166 coupled to the link device 134 and also structures connected to the inner ring of the elevation bearing 166 rotate together.

In the meantime, in a case the vertical drive motor 160 operates and the drive axis 161 rotates, the screw axis 167 coupled thereto rotates. In a case the screw axis 167 rotates, the nut member 168 coupled to the vertical movement body 162 moves vertically by its interaction to the screw axis 167. At this time, the vertical movement body 162 shifts vertically with the nut member 168 along the guide axis 164.

As such, according to a 3-dimension range finder sensor 100 of an embodiment of the present invention, a vertical drive system for shifting the mirror assembly 130 in a vertical direction can be disposed at the outer side of the cylindrical body 141 separately from a horizontal drive system, thereby reducing the entire height. And, by guiding the vertical movement body 162 moving vertically by the vertical drive motor 160 using a plurality of guide axis 164, the vertical movement body 162 can shift vertically safely.

Also, by adopting the inner ring of the elevation bearing 166 as a connection bearing connecting the vertical drive part and the horizontal drive part in a rotation mode, the guide axis 164 or the nut member 168 may be provided as one or more sliding guide means in a fixed outer ring structure. And, the vertical drive system is supported at both ends by the guide axis 164 or the nut member 168, thereby improving safeness upon a vertical drive.

Also, an installation interval of a pair of rotation body support bearings 153 rotatingly supporting the cylindrical body 141 may be widened, thereby reducing the run-out of the cylindrical body 141. Also, by employing a void space of a product outer edge part, the size reduction of a product can be expected.

According to a 3-dimension range finder sensor of one embodiment of the present invention, a vertical drive system shifting a mirror assembly in a vertical direction is disposed at the outer side of a cylindrical body supporting the mirror assembly separately from a horizontal drive system. Therefore, the run-out of a product may be reduced, and the reduction of product height is possible.

Also, according to a 3-dimension range finder sensor of one embodiment of the present invention, a vertical movement body for moving a mirror assembly in a vertical direction may be supported by a guide axis extended to the vertical direction, thereby performing a vertical movement safely.

The embodiment of the present invention described in the foregoing part and shown in the drawings should not be understood in a sense of limiting the technical spirit of the present invention. The scope of the present invention is only restricted to substance stated in the claims, and those skilled in the art may improve and change the technical spirit of the present invention in various forms. Therefore, such improvements and changes would fall in the scope of the present invention as long as they are obvious to those skilled in the art.

What is claimed is:

1. A 3-dimension range finder sensor comprising:
a mirror reflecting emitted light and incident light;
a mirror support tiltably supporting the mirror;
a cylindrical body coupling the mirror support to its one side and being of a hollow shape in at least one part to allow the emitted light and the incident light to pass therethrough;
a horizontal drive motor installed on a base for supportively rotating the cylindrical body;
a link device connected to the mirror for tilting the mirror;
a vertical drive motor disposed at a lateral surface of the horizontal drive motor on the base; and
a power transmission part interposed between the vertical drive motor and the link device and transmitting the power of the vertical drive motor to the link device for the link device to tilt the mirror.

2. The range finder sensor of claim 1, wherein the power transmission part comprises an elevation bearing, and
wherein the elevation bearing comprises an inner ring slidingly inserted around the outer circumference of the cylindrical body and connected to the link device, and an outer ring connected to the vertical drive motor.

3. The range finder sensor of claim 2, comprising a rotation body support bearing rotatively supporting the cylindrical body at the lower part of the elevation bearing.

4. The range finder sensor of claim 2, wherein the power transmission part further comprises a screw axis coupled to a drive axis of the vertical drive motor, and a nut member coupled by a screw to the screw axis, and
wherein the nut member is connected to the elevation bearing elevatingly inserted into the outer circumference of the cylindrical body and elevating up/down upon the rotation of the vertical drive motor to vertically shift the elevation bearing.

5. The range finder sensor of claim 1, wherein the range finder sensor comprises guide axes guiding the vertical movement of the link device, and
wherein the vertical drive motor is disposed in the opposite side of the guide axis with placing the cylindrical body between them.

6. The range finder sensor of claim 5, wherein the three guide axes and the vertical drive motor are disposed in the periphery of the cylindrical body at a 90° interval.

7. The range finder sensor of claim 1, wherein the power transmission part comprises a screw axis coupled to a drive axis of the vertical drive motor, and a nut member coupled by a screw to the screw axis, and
wherein the nut member is connected to an elevation bearing elevatingly inserted into the outer circumference of the cylindrical body and elevating up/down upon the rotation of the vertical drive motor to vertically shift the elevation bearing.
